(19) United States
(12) Patent Application Publication
(10) Pub. No.: US 2009/0235110 A1
(43) Pub. Date: Sep. 17, 2009

(54) INPUT/OUTPUT CONTROL METHOD, INFORMATION PROCESSING APPARATUS, COMPUTER READABLE RECORDING MEDIUM

(75) Inventor: Kazushige KUROKAWA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/404,539

(22) Filed: Mar. 16, 2009

(30) Foreign Application Priority Data
Mar. 17, 2008 (JP) 2008-68477

(51) Int. Cl. G06F 11/07

(52) U.S. Cl. 714/3; 714/E11.023

(57) ABSTRACT

An input/output control method for an information processing apparatus that is connected to an input/output device through first and second paths, monitors an input/output response to an input/output request issued to the input/output device through the first path, and performs a timeout process when the input/output response is not present within a timeout time. The input/output control method includes predicting a timeout time to the input/output request on the basis of statistic information that the information processing apparatus obtains by monitoring the input/output response, detecting an error on the first path when an input/output response to the input/output request is not present within the predicted timeout time and disconnecting the first path when the error on the first path is detected.

### CROSS-REFERENCE TO RELATED APPLICATIONS

This application is based upon and claims priority to prior Japanese Patent Application No. 2008-68477 filed on Mar. 17, 2008 in the Japan Patent Office, the entire contents of which are incorporated herein by reference.

### FIELD

Various embodiments of the invention discussed herein relate to an input/output control method, an information processing apparatus, and a computer-readable recording medium.

### BACKGROUND

FIG. 1 is a diagram for explaining an example of communication control between a server serving as an information processing apparatus and a disk array serving as an input/output device. A system depicted in FIG. 1 has a server 1 and a disk array 2. The server 1 and the disk array 2 are connected to each other by a transmission path 3 such as an FC (Fibre Channel), an SCSI (Small Computer System Interface), or an SAS (Serial Attached SCSI). The server 1 has an application 11, I/O (Input/Output) multipath control software 12, and a target driver 13. The target driver 13 has an HBA (Host Bus Adapter) driver 13-1 and an HBA 13-2. The disk array 2 has a plurality of disk devices 22 functioning as a controller 21 and an input/output device.

When an I/O request is issued from the application 11, an I/O process is performed to a target I/O device by the I/O multipath control software 12 and the HBA driver 13-1. In this case, the I/O multipath control software 12 controls the plurality of transmission paths 3 between the server 1 and the disk array 2, and the HBA driver 13-1 communicates with the target driver 13 and the disk array 2 that generates an I/O command to the target device.

FIG. 2 is a diagram for explaining an operation timing of the system depicted in FIG. 1. The I/O multipath control software 12 receives an I/O request from the application 11 on a layer higher than that of the I/O multipath control software 12 in a layer structure of software in the server 1. The I/O multipath control software 12 starts an internal timer that measures an elapsed time after the I/O request is issued from the application 11, and then issues an I/O issue request to the target driver 13 on a lower layer. Thereafter, the I/O multipath control software 12 monitors an I/O response from the target driver 13 to which the I/O issue request has been issued and performs a timeout process when an I/O response is not present within the timeout time (i.e., an I/O response monitoring time) by using the elapsed time measured by the internal timer. In a connection between the server 1 and the disk array 2, a path is made redundant by using the I/O multipath control software 12. Even though one connection path is interrupted, a configuration in which communication can be continued from the redundant channel can be achieved.

In the timeout process, it is determined that an error occurs in a path on which timeout occurs, disconnection is performed such that the path on which the timeout occurs is not used, and the path is switched to another redundant channel to reissue an I/O issue request to the target driver 13 on the redundant channel. In FIG. 2, the error occurring on the path is indicated by an X mark. In a device that performs the timeout process, even though the disk array 2 normally operates, timeout occurs in an overload state, the path is clogged, or a disk volume is disconnected.

In particular, in a system called a social system or the like, it is requested that, even through a failure occurs in the disk array 2 or on the path, an error is detected within a short period of time to switch the path to a redundant channel, and a process time is prevented from being elongated by switching to the redundant channel. For this reason, the timeout time of the I/O multipath control software 12 is set to a relatively short time.

When a large number of I/O requests are issued to the disk array 2 to exceed the processing capability of the disk array 2, an I/O response is not output from the target driver 13 within the timeout time, and timeout occurs. Originally, monitoring of the I/O response is used to detect that an I/O response does not occur due to occurrence of an error caused by a failure or the like in the disk array 2 or on the path. For this reason, the disk array 2 normally operates in an overload state: Even though an actual error does not occur, an error is erroneously detected by I/O monitoring due to load delay in the overload state. As a result, even though the disk array 2 can be used without any trouble, the I/O multipath control software 12 determines that a failure occurs, clogging the system in which the error is detected. An overload state in the disk array 2 occurs in a data backup state, a restoration state, a dump collecting state, a business batch process, a business load increasing state caused by an unexpected rapid increase in site access, or the like.

In particular, in data backup, an operation (for example, Recovery Manager available from Oracle Corp.) that collects backups during business called on-line backup is popularized, and chances of causing an I/O request for business and an I/O request of data backup to occur in parallel with each other are increasing. For this reason, parameters of the system are changed in a data backup operation, and a timeout time may be uniformly set to be long. However, in this state, the timeout time of an I/O response to an I/O request of the business is also set to be long. For this reason, this measure does not serve as a solution.

A disk volume is mirrored and made redundant by volume management software, software RAID (Redundant Arrays of Independent Disks), or the like to improve reliability. In redundancy in the disk array, a timeout time is set as in the above case, and an operation is performed such that the system is switched to a mirrored system upon the failure of the disk array or the path.

[Patent Document 1] Japanese Laid-open Patent Publication No. 56-90354

[Patent Document 2] Japanese Laid-open Patent Publication No. 4-177547

[Patent Document 3] Japanese Laid-open Patent Publication No. 2001-147866

[Patent Document 4] Japanese Laid-open Patent Publication No. 2006-235909

### SUMMARY

An input/output control method for an information processing apparatus that is connected to an input/output device through first and second paths, monitors an input/output response to an input/output request issued to the input/output device through the first path, and performs a timeout process when the input/output response is not present within a timeout time, includes predicting a timeout time to the input/output request based on statistic information that the information processing apparatus obtains by monitoring the input/output response, detecting an error on the first path when an input/output response to the input/output request is not present within the predicted timeout time and disconnecting the first path when the error on the first path is detected.

An information processing apparatus that is connected to an input/output device through a first path and a second path, monitors an input/output response to an input/output request issued to the input/output device through the first path, and performs a timeout process when the input/output response is not present within a timeout time, including a prediction unit that predicts a timeout time to the input/output request based on statistic information that the information processing apparatus obtains by monitoring the input/output response, a detection unit that detects an error on the first path when an input/output response to the input/output request is not present within the predicted timeout time, and a disconnection unit that disconnects the first path when the error on the first path is detected.

A computer-readable recording medium storing an input/output control program for an information processing apparatus that is connected to an input/output device through first and second paths, monitors an input/output response to an input/output request issued to the input/output device through the first path, and performs a timeout process when the input/output response is not present within a timeout time, the program when executed by a computer causes the computer to perform a method including predicting a timeout time to the input/output request based on the basis of statistic information that the information processing apparatus obtains by monitoring the input/output response, detecting an error on the first path when an input/output response to the input/output request is not present within the predicted timeout time; and disconnecting the first path when the error on the first path is detected.

### BRIEF DESCRIPTION OF DRAWINGS

FIG. 1 is a diagram for explaining an example of communication control between a server and a disk array;

FIG. 2 is a diagram for explaining an operation timing of a system depicted in FIG. 1;

FIG. 3 is a diagram for explaining communication control between a server and a disk array in a first embodiment of the present invention;

FIG. 4 is a diagram for explaining an operation timing of a system depicted in FIG. 3;

FIG. 5 is a diagram for explaining an I/O request process;

FIGS. 6A and 6B are diagrams depicting an example of a buf structure;

FIG. 7 is a flow chart for explaining an I/O request accepting process of an I/O management function of I/O multipath control software;

FIG. 8 is a flow chart for explaining a timeout time setting process of the I/O management function of the I/O multipath control software;

FIG. 9 is a diagram depicting an example of management information managed by an LU management function;

FIG. 10 is a flow chart for explaining a path status returning process of the LU management function of the I/O multipath control software;

FIG. 11 is a flow chart for explaining a number-of-issues adding process of the LU management function of the I/O multipath control software;

FIG. 12 is a flow chart for explaining an I/O response time returning process of the LU management function of the I/O multipath control software;

FIG. 13 is a flow chart for explaining an I/O monitoring timer function of the I/O multipath control software;

FIG. 14 is a flow chart for explaining a disk array monitoring timer function of the I/O multipath control software;

FIG. 15 is a diagram for explaining communication control between a server and disk array in a second embodiment of the present invention;

FIG. 16 is a diagram for explaining an operation timing in a read state in a system depicted in FIG. 15;

FIG. 17 is a diagram for explaining an operation timing in a write state in the system depicted in FIG. 15;

FIG. 18 is a flow chart for explaining an I/O request accepting process of an I/O management function of volume management software;

FIG. 19 is a flow chart for explaining a timeout time setting process of the I/O management function of volume management software;

FIG. 20 is a diagram depicting an example of management information managed by a disk volume management function;

FIG. 21 is a flow chart for explaining a path status returning process of the disk volume management function of volume management software;

FIG. 22 is a flow chart for explaining a number-of-issues adding process of the disk volume management function of the volume management software;

FIG. 23 is a flow chart for explaining an I/O response time returning process of the disk volume management function of the volume management software;

FIG. 24 is a flow chart for explaining an I/O monitoring timer function of the volume management software;

FIG. 25 is a flow chart for explaining a disk array monitoring timer function of the volume management software;

FIG. 26 is a diagram for explaining communication control between a server and a disk array in a third embodiment of the present invention; and

FIG. 27 is a diagram for explaining an operation timing of a system depicted in FIG. 26.

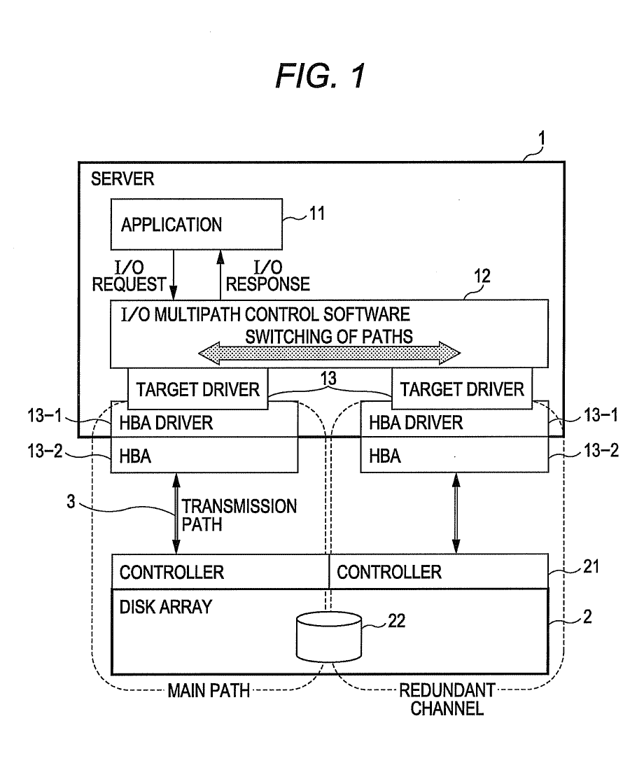

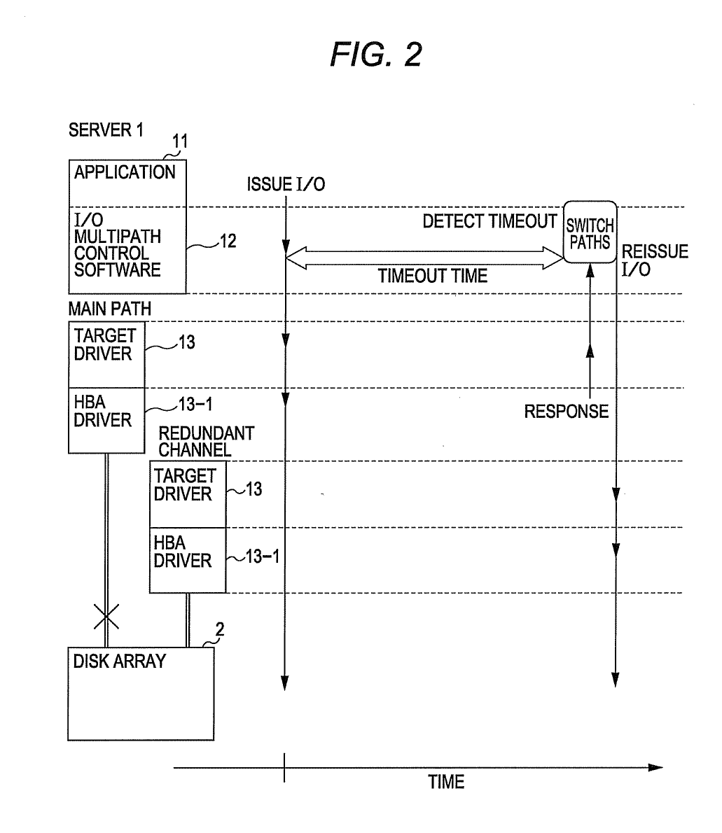

### DESCRIPTION OF EMBODIMENTS

In the disclosed input/output control method, information processing apparatus, and computer-readable recording medium, when an I/O request is issued, it is determined whether timeout times of I/O devices are elongated. The timeout times of the I/O devices are changed as needed, and an I/O response is monitored to detect occurrence of an error. More specifically, the timeout times of the I/O devices are elongated as needed, overload states of the I/O devices are prevented from being erroneously detected as occurrence of errors, a normally operated I/O device is prevented from being needlessly disconnected, or a path to a normally operated I/O device is prevented from being needlessly switched.

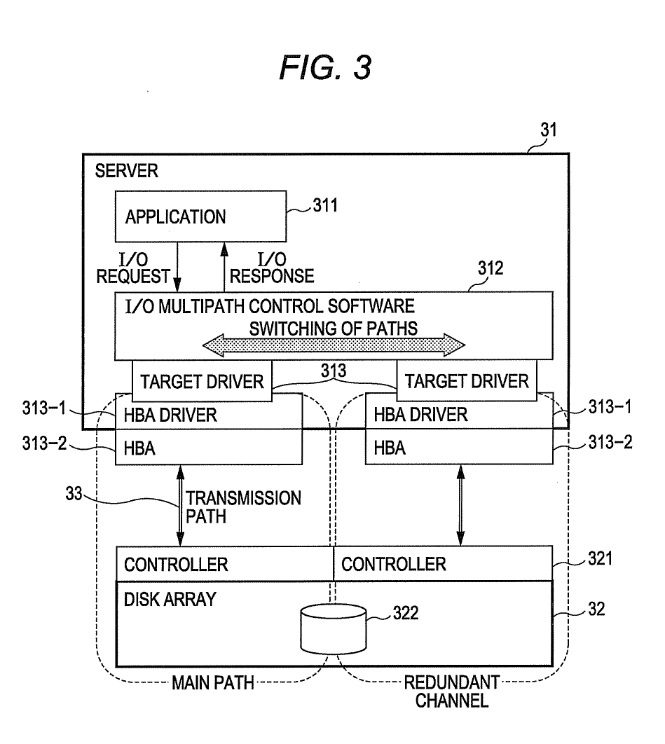

Embodiments of an input/output control method, an information processing apparatus, and a computer-readable recording medium according to the present invention will be described below with reference to FIG. 3 and the subsequent drawings.

### First Embodiment

An input/output control method, an information processing apparatus, and a computer-readable recording medium in a first embodiment will be described below.

FIG. 3 is a diagram for explaining communication control between a server and a disk array in the first embodiment. The system depicted in FIG. 3 has a server 31 and a disk array 32, which are connected to each other by a transmission path 33 such as an FC, an SCSI, or an SAS. The server 31 has an application 311, I/O multipath control software 312, and a target driver 313. The target driver 313 has an HBA driver 313-1 and an HBA adaptor 313-2. The disk array 32 has a controller 321 and a plurality of disk devices 322 functioning as I/O devices. In a layer structure of software in the server 31, the application 311, the I/O multipath control software 312, and the target driver 313 are ordered from the upper layer.

The I/O multipath control software 312 recognizes a state of a connection path between the server 31 and the disk array 32 to issue an I/O request accepted from the application 311 to the disk array 32 through an appropriate path. The I/O multipath control software 312 detects abnormality of each path, performs connection management to each path, and makes a decision such that the I/O multipath control software 312 is notified of an I/O response to an I/O issue request issued to a layer lower than that of the I/O multipath control software 312 by an error. Alternatively, the I/O multipath control software 312 determines abnormality of each path by timeout monitoring in the I/O multipath control software 312. In this embodiment, the I/O multipath control software 312 is on the assumption that the number of simultaneous issues of I/O issue requests issued to a lower layer is not limited. The target driver 313 issues an I/O command to the target device to manage the target device. The target driver 313-1 controls the HBA adaptor 313-2. When the HBA driver 313-1 receives an I/O issue request, the HBA driver 313-1 performs communication process or the like with the disk array 32. The HBA driver 313-1 measures a time (service_time) from when an I/O request is issued to the I/O device to when a process for the I/O request ends, and puts the measured service_time in a private region of a scsi_pkt structure to give the scsi_pkt structure to the target driver 313. The target driver 313 puts the service_time of the scsi_pkt structure received from the HBA driver 313-1 in a private area of the buf structure to give the buf structure to the I/O multipath control software 312.

When an I/O request is issued from the application 311, I/O control to the target I/O device is performed by the I/O multipath control software 312 and the HBA driver 313-1. In this case, the I/O multipath control software 312 controls the plurality of transmission paths 33 between the server 31 and the disk array 32. The HBA driver 313-1 controls the target driver 313 that generates an I/O command to the target device and the HBA 313-2 that actually performs communication with the disk array 32.

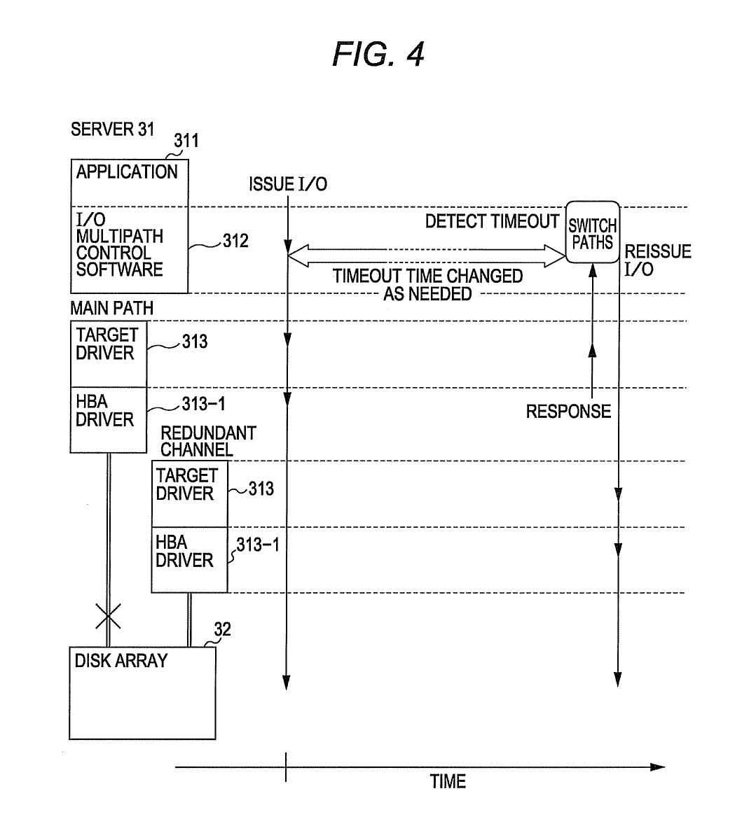

FIG. 4 is a diagram for explaining an operation timing of the system depicted in FIG. 3. When the I/O multipath control software 312 receives an I/O request from the application 311 on a layer higher than that of the I/O multipath control software 312 in the layer structure of the software in the server 31, the I/O multipath control software 312 elongates a timeout time of the target device (i.e., I/O response monitoring time) as needed. Furthermore, the I/O multipath control software 312 starts an internal timer that measures a time elapsed after an I/O request is issued, and then issues an I/O issue request to the target driver 313 on a lower layer on a main path side. Thereafter, the I/O multipath control software 312 monitors an I/O response from the target driver 313 to which an I/O issue request is issued, and performs a timeout process by using the elapsed time measured by the internal timer when no I/O response is output within the timeout time. In the timeout process, it is determined that an error occurs on the main path on which timeout occurs, disconnection is performed such that the path on which the timeout occurs is not used, and the path is switched to another redundant channel. An I/O issue request is then reissued to the target driver 313 on the redundant channel side. In a connection between the server 31 and the disk array 32, the path is made redundant by using the I/O multipath control software 312. Even though one connection path is interrupted, connection can be continued from the redundant channel. In FIG. 4, an error occurring on the main path is indicated by an X mark.

In the example in FIG. 4, when the disk array 32 normally operates, a timeout time is elongated such that timeout does not occur even in an overload state. For this reason, when no error occurs on the path, the path is not disconnected, or a disk volume is not disconnected.

The I/O multipath control software 312 has an I/O management function, an LU (Logical Unit) management function, an I/O monitoring timer function, and a disk array management function. The I/O management function manages acceptance of an I/O request from the application 311 on the upper layer and an I/O issue request issued to the target driver 313. The I/O management function sets a timeout time in acceptance of an I/O request and monitors an I/O response.

An LU has one disk device 322 or a plurality of disk devices 322 in the disk array 32, and is a unit managed as one region when viewed from an operating system (OS) (not depicted) in the server 31. The LU management function manages a path to the LU. More specifically, instance names of the target drivers 313 are switched to switch paths to the LU. The LU management function manages an issue status of an I/O request. More specifically, the number of issues of I/O issue requests of each LU, average response time, and the like are calculated. Furthermore, the LU management function manages an error status of the I/O device constituting the LU and sets an error flag when an error occurs within a predetermined period of time.

The I/O monitoring timer function periodically (for example, every second) starts the I/O monitoring timer, subtracts “1” from an I/O monitoring timer value of the buf structure of all I/O requests that are being issued. The I/O monitoring timer function determines timeout when the I/O monitoring timer value is “0”, and notifies the I/O management function that the I/O monitoring timer value is “0”.

The disk array monitoring timer function periodically (for example, every second) starts a disk array monitoring timer, issues a request sense to the LU of the disk array 32, and checks whether hardware error (failure) information (Sense) is present.

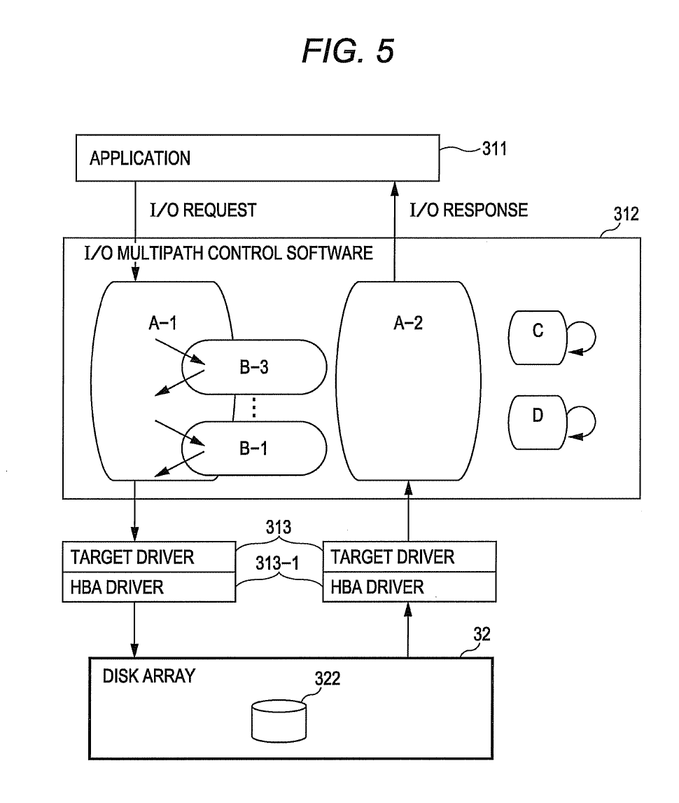

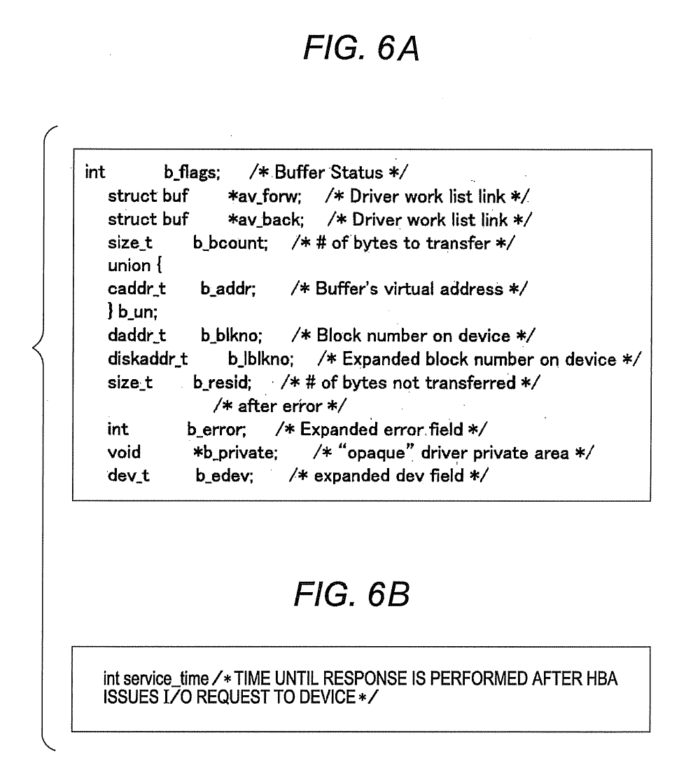

FIG. 5 is a diagram for explaining an I/O request process, and FIG. 6 are diagrams depicting an example of the buf structure. A buf structure as depicted in FIG. 6A is a structure used in Solaris Operation System, and is defined by http://docs.sun.com/app/docs/doc/816-4854/block-3?|=en&q=Writing+Device+Drivers&a=view.

In this embodiment, although the buf structure itself is not needed to be changed, b_slow representing that a timer time can be elongated is added as a flag used as b_flags. A buffer region (buf) used in the I/O management function of the I/O multipath control software 312 corresponds to an I/O request and extended as depicted in FIG. 6B.

The I/O management function of the I/O multipath control software 312 causes a timeout time setting process A-2 to determine whether the I/O monitoring timer value can be elongated, by performing a process of determining whether the following I/O monitoring timer value can be elongated and a process of predicting I/O response time.

The process of determining whether the I/O monitoring timer value can be elongated is performed by newly constructing b_slow that can be set in the b_flags of the buf structure. When the application 311 issues an I/O request, the b_slow is set in the b_flags of the buf structure. After the I/O multipath control software 312 receives the I/O request, the I/O multipath control software 312 checks the b_flags of the buf structure. When the b_slow is set, the I/O multipath control software 312 determines that the I/O monitoring timer value can be elongated.

The process of predicting an I/O response time of an I/O request to be issued predicts a predicted I/O response time from statistic information. The statistic information may be information related to, for example, the I/O response time and information related to an error.

When the I/O response time is predicted from the statistic information related to the I/O response time, for example, the I/O response time is predicted from “predicted I/O response time”=“the number of accepted I/Os (order)”×“average I/O response time”, and it is determined whether an I/O response time falls within the defined timeout time. In an actual determination, the defined timeout time may be multiplied by a safe coefficient (for example, 0.8 or the like). In this case, the number of accepted I/Os (order) is the number of I/O requests processed by the I/O multipath control software 312 to the LU (disk 322) serving as a target of an I/O request to be issued.

When the target driver 313 and the HBA driver 313-1 on a lower layer of the I/O multipath control software 312 have a function of notifying the I/O multipath control software 312 of the I/O response time, the average I/O response time is defined as follows. That is, the average I/O response time is defined as average time until the disk array 32 responds to the target driver 313 after the HBA driver 313-1 issues an I/O request to the disk array 32. More specifically, the HBA driver 313-1 writes information obtained by measuring the I/O response time in the scsi_pkt structure to give the scsi_pkt structure to the target driver 313, and the target driver 313 writes the information in the buf structure to give the buf structure to the I/O multipath control software 312 (or volume management software 315). In this manner, the I/O multipath control software 312 (or the volume management software 315) calculates an average I/O response time that is an average value of the I/O response times of every I/O request.

On the other hand, when the I/O response time is measured by the I/O multipath control software 312, a time until the I/O response returns to the I/O multipath control software 312 after the I/O multipath control software 312 issues an I/O issue request to the target driver 313 on the lower layer is measured as I/O response time. The I/O response times measured as described above are summed up, and the resultant value is defined as an average value of the I/O response times, i.e., average I/O response time. In this case, the HBA driver 313-1 does not need to perform a process of measuring a time (service_time) until the I/O request process is ended after a request is issued to the I/O device, writing the measured service_time in a private region of the scsi_pkt structure, and giving the scsi_pkt structure to the target driver 313. The target driver 313 does not need to perform a process of writing the service_time on the scsi_pkt structure received from the HBA driver 313-1 in the private area of the buf structure and giving the buf structure to the I/O multipath control software 312.

In the embodiment, with respect to the calculation for the average I/O response time, the following rules are set. More specifically, when the I/O response exceeds the timeout time, the I/O response is not considered in calculation of the average I/O response time. In this case, when an I/O response is not made by an LU for which the average I/O response time is calculated for a predetermined period of time (for example, 1 second), the average I/O response time and the count of I/O acceptances are reset to “0”. An average value of I/O response times is calculated when data of a predetermined number of I/O responses (for example, data of about max_throttle×4 (255×4) I/O responses) are summed up in the target driver 313.

I/O monitoring timer values of the I/O multipath control software 312 (or the volume management software 315) can be changed as follows. When the I/O monitoring timer value can be increased, the I/O multipath control software 312 (or the volume management software 315) writes slow_I/O_flag in a management region of each of the I/O requests set in issue information of the I/O requests held in the I/O multipath control software 312 when the I/O requests are issued. The I/O response monitoring timer function of the I/O multipath control software 312 (or the volume management software 315) continues counting until the I/O monitoring timer value is several times (for example, ten times) the timeout time when the slow_I/O_flag is written in a management region of each of the I/O requests.

When an I/O response time is predicted from statistic information related to an error of the disk device or the LU, an I/O response time is predicted by the following method, and it is determined whether the predicted I/O response time falls within the defined timeout time. For example, when the following statistic information is used, and when an error occurs in the disk device or the LU to which an I/O request is issued within a predetermined period of time (for example, one minute, 10 minutes, 30 minutes, 1 day, or the like), the timeout time is not elongated. In contrast to this, when statistic information related to the error is not present, a process of predicting an I/O response time from statistic information related to the I/O response time may be made valid. Statistic information held by the system or the OS includes statistic information such as iostat information obtained by summing up error occurrence information by the target driver 313 and hardware error sense information, such as SCSI sense obtained by summing up hardware errors. Statistic information of an I/O error response from a lower layer of the I/O multipath control software 312 (or the volume management software 315) includes a total or the like related to the number of I/O error responses returned to an I/O issue request to the target driver 313 or the like on the lower layer.

A diagnosis result of the presence/absence of a hardware error may be periodically obtained. In this case, inquiry (request sense) of the presence/absence of a hardware error is periodically made to each LU of the disk array 32, and a process of predicting an I/O response time of an I/O request to be issued only when no hardware error is present (no sense) may be valid.

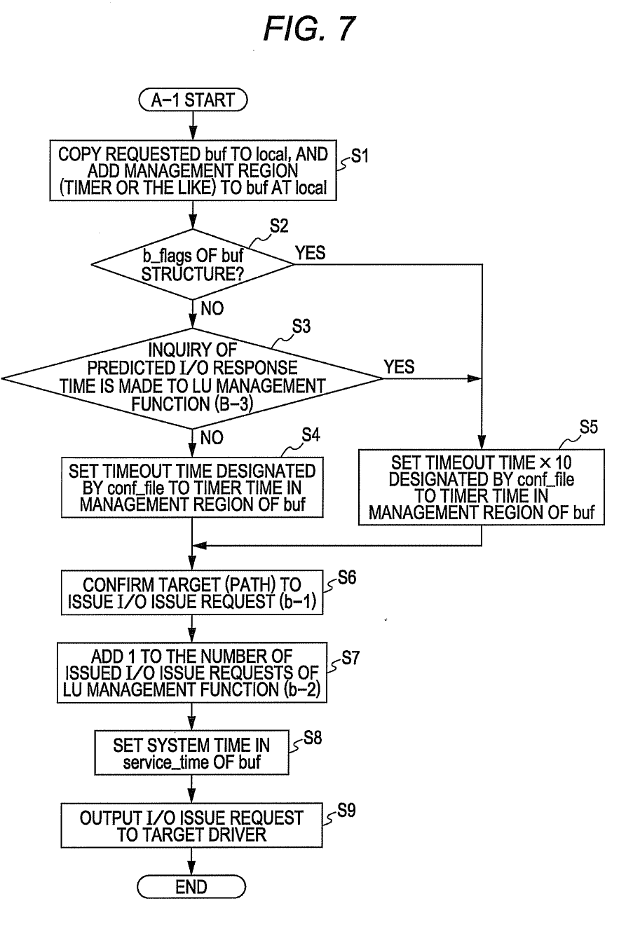

FIG. 7 is a flow chart for explaining an I/O management function of the I/O multipath control software 312, and depicts an I/O request accepting process A-1.

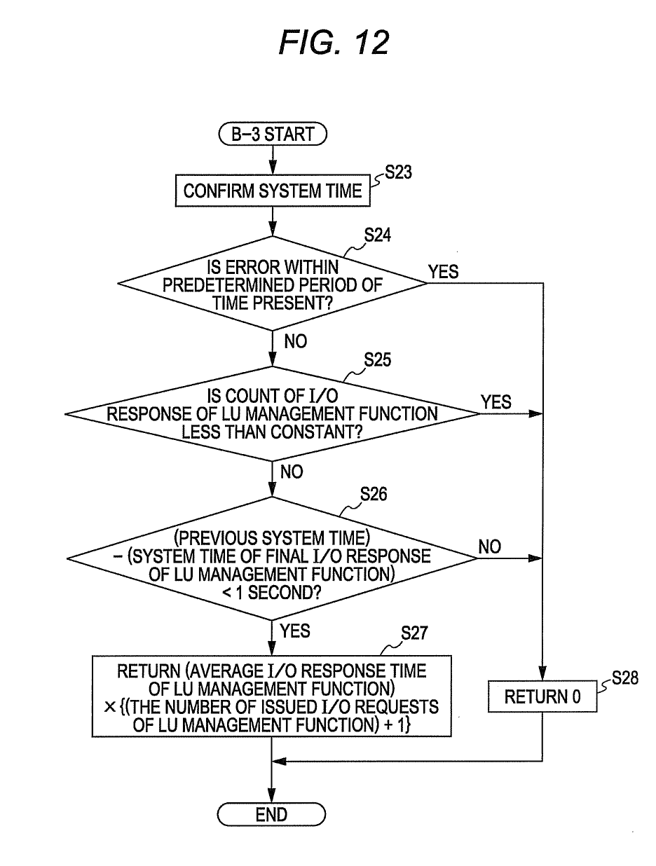

In FIG. 7, when the I/O multipath control software receives an I/O request from the application 311, the I/O multipath control software copies buf needed by the I/O request in step S1 in a local buffer region (local) to add a management region of a timer time or the like to the local. In step S2, it is determined whether b_slow is set in b_flags of the buf structure. When a determination result is NO, the process shifts to step S3. In step S3, the I/O multipath control software inquires at an LU management function about a prediction response time to the I/O request (I/O response time returning process B-3 described later with reference to FIG. 12) to determine whether the prediction response time is the timeout time or more. When a determination result in step S3 is NO, i.e., when the prediction response time is a designated timeout time or less, in step S4, a timeout time designated by conf_file at the timer time in the buf management region is set as prediction timeout time. On the other hand, when the determination result in step S2 or S3 is YES, i.e., when the prediction response time is the designated timeout time or more, in step S5, a timeout time obtained by multiplying the timeout time designated by the conf_file at the timer time in the buf management region by an arbitrary constant value (for example, 10) is set as the prediction timeout time.

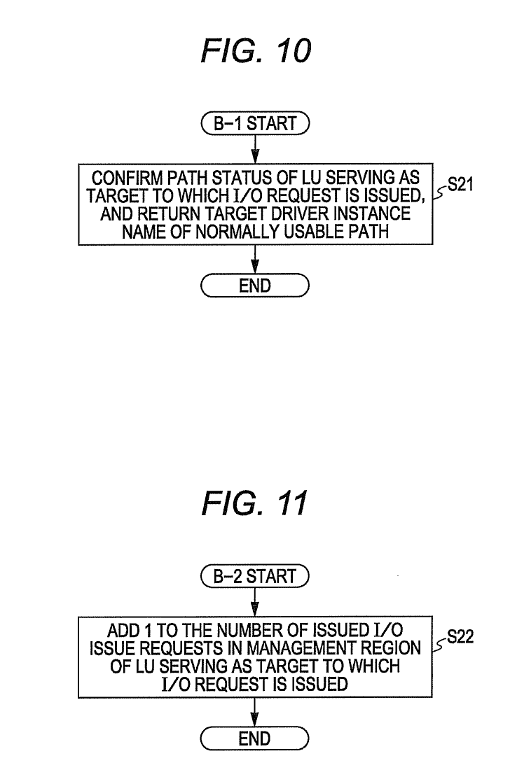

After the execution of step S4 or step S5, in step S6, a target device to issue an I/O issue request to the LU management function is confirmed (path status returning process B-1 described later with reference to FIG. 10). In step S7, the LU management function is designated to increment the number of issued I/O issue requests (number-of-issue adding process B-2 described later with reference to FIG. 11). In step S8, system time in the server 31 is set as a service_time of the buf. In step S9, an I/O issue request is issued to the target driver 313 to end the process.

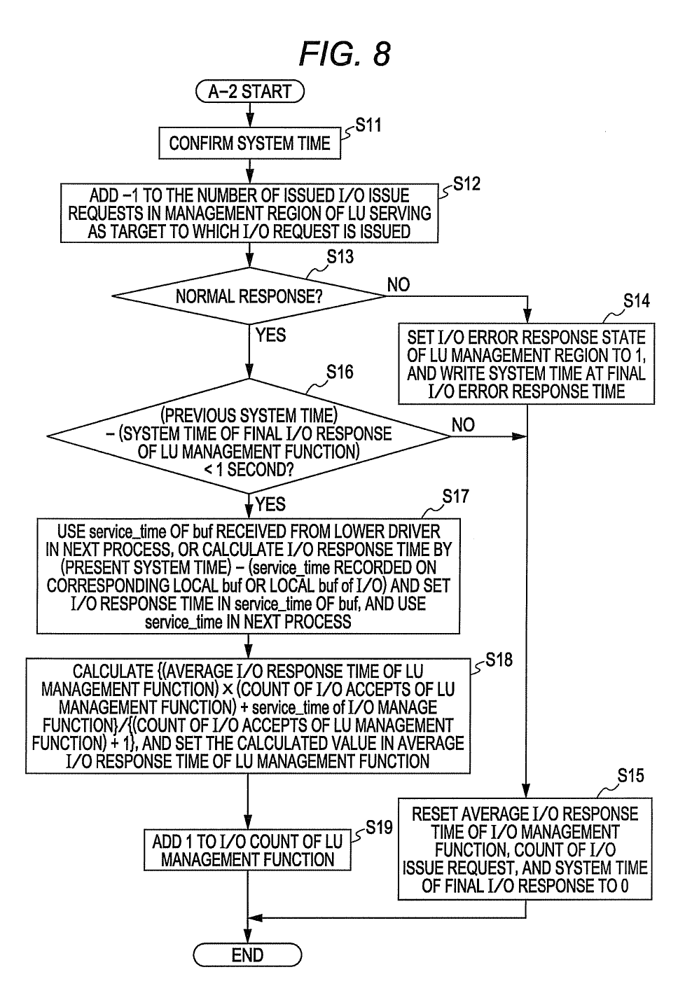

FIG. 8 is a flow chart for explaining the I/O management function of the I/O multipath control software 312, and depicts the timeout time setting process A-2.

In FIG. 8, the system time in the server 31 is confirmed in step S11, and the number of issued I/O issue requests in the management region of the LU of the target device to which an I/O request is issued is decremented. In step S13, it is determined whether a normal response to the I/O request is obtained. When a determination result is NO, i.e., when a normal response is not obtained, the process shifts to step S14. In step S14, an I/O error response state of the management region of the LU is set to “1”, and the system time is written as an I/O error response time that finally occurs, and the process shifts to step S15. In step S15, an I/O average response time of the I/O management function, a count of an I/O issue request, and system time of the final I/O response are reset to “0” to end the process.

On the other hand, an operation in step S16 when the determination result in step S13 is YES, i.e., a normal response is obtained, is as follows. In step S16, it is determined whether a time obtained by subtracting system time of the final I/O response managed by the LU management function from previous system time is less than 1 second or whether the system time of the final I/O response managed by the LU management function is “0”. When the determination result is NO, the process shifts to step S15.

An operation in step S17 when a determination result in step S16 is YES is as follows. In step S17, the service_time of the buf received from the target driver 313 is prepared to be used in the next process, or an I/O response time obtained by subtracting the service_time put in the local of the target device from the present system time is put in the service_time of the buf and prepared to be used in the next process. In step S18, {(average I/O response time of LU management function)×(count of the number of accepted I/Os of LU management function)+(service_time of I/O management function)}/{(count of the number of accepted I/Os of LU management function)+1} is calculated to be reflected in the average I/O response time of the LU management function. In step S19, “1” is added to the count of the number of accepted I/Os of the LU management function to end the process.

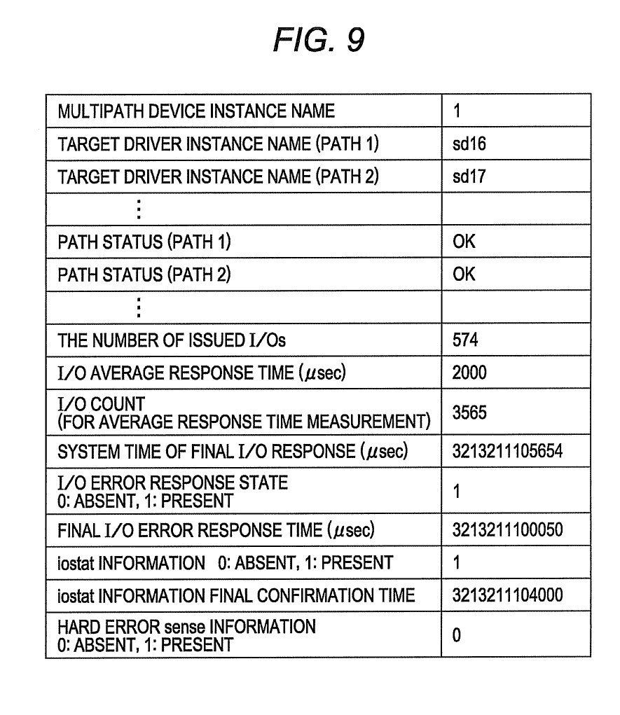

The LU management function manages management information depicted in FIG. 9 for each LU. FIG. 9 is a diagram depicting an example of management information managed by the LU management function. As depicted in FIG. 9, the management information includes a multipath device instance name, a target driver instance name (path 1), a target driver instance name (path 2), . . . , and a target driver instance name (path N). The management information includes a path status (path 1), a path status (path 2), . . . , a path status (path N), the number of issued I/O requests, an average I/O response time, the number of accepted I/Os for measuring an average I/O response time, system time of a final I/O response, an I/O error response state, and a final I/O error response time. Furthermore, the management information includes iostat information, iostat information final confirmation time, and hardware error sense information.

FIG. 10 is a flow chart for explaining an LU management function of the I/O multipath control software 312, and depicts a path status returning process B-1.

In FIG. 10, when an inquiry is made from step S6 depicted in FIG. 7, a path status of an LU serving as an object to which an I/O request is issued is confirmed in step S21, and a target driver instance name of a normally usable path is returned to end the process.

FIG. 11 is a flow chart for explaining the LU management function of the I/O multipath control software 312, and depicts a number-of-issue adding process B-2.

In FIG. 11, when a designation is made in step S7 depicted in FIG. 7, in step S22, “1” is added to the number of issued I/O issue requests of the management region of an LU serving as an object to which an I/O request is issued to end the process.

FIG. 12 is a flow chart for explaining the LU management function of the I/O multipath control software 312, and depicts an I/O response time returning process B-3.

In FIG. 12, when an inquiry of a predicted response time is made in step S3 depicted in FIG. 7, system time is confirmed in step S23. It is determined from statistic information in step S24 whether an error is present within a predetermined period of time. In step S24, for example, in an I/O error response state, when the iostat information includes an error, and when the information within a predetermined period of time is present, it is determined that an error is present. When hardware error sense information is present, it is determined that an error is present. When a determination result in step S24 is NO, it is determined in step S25 whether a count of I/O responses of the LU management function is less than a predetermined value, i.e., less than max_throttle×4(255×4). When a determination result in step S25 is NO, it is determined in step S26 whether a time obtained by subtracting system time of a final I/O response managed by the LU management function from previous system time is less than 1 second. When a determination result in step S26 is YES, (average I/O response time)×{(the number of issued I/O requests)+1} managed by the LU management function is returned to the I/O management function to end the process. On the other hand, when the determination result in step S24 or S25 is YES, or when the determination result in step S26 is NO, in step S28, “0” is returned to the I/O management function to end the process.

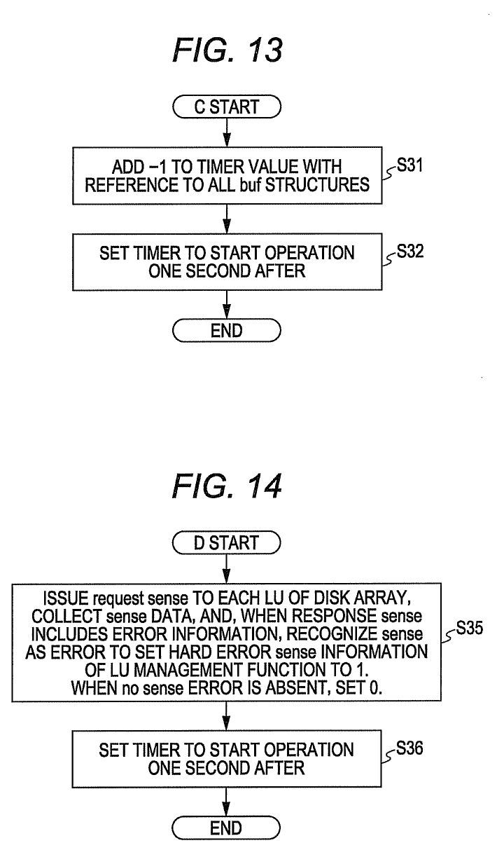

FIG. 13 is a flow chart for explaining an I/O monitoring timer function of the I/O multipath control software 312. In FIG. 13, when the I/O monitoring timer function is started, in step S31, “1” is subtracted from an I/O monitoring timer value with reference to all buf structures. In step S32, a self-timer is set such that the I/O monitoring timer function is started after, for example, 1 second to end the process.

FIG. 14 is a flow chart for explaining a disk array monitoring timer function of the I/O multipath control software 312. In FIG. 14, when the disk array monitoring timer function is started, in step S35, a request sense is issued to each LU of the disk array 32, and sense information is collected. In step S35, when the sense information to the request sense includes error information, hardware error sense information of the LU management function is set to “1” as an error. When no hardware error is present (no sense), “0” is set. In step S36, the self-timer is set such that the disk array monitoring timer function is started, for example, 1 second after to end the process.

According to the embodiment, a timeout time of each I/O device is elongated as needed to make it possible to prevent an overload state of the I/O device from being erroneously detected as occurrence of an error. Furthermore, according to the embodiment, when the timeout time of each I/O device is elongated as needed, a normally operated I/O device can be prevented from being needlessly disconnected, or a path to the normally operated I/O device is prevented from being needlessly switched.

### Second Embodiment

An input/output control method, an information processing apparatus, and a computer-readable recording medium according to a second embodiment will be described below. In the first embodiment, the present invention is applied to I/O multipath control software. However, in the second embodiment, the case in which the present invention is applied to volume management software will be described.

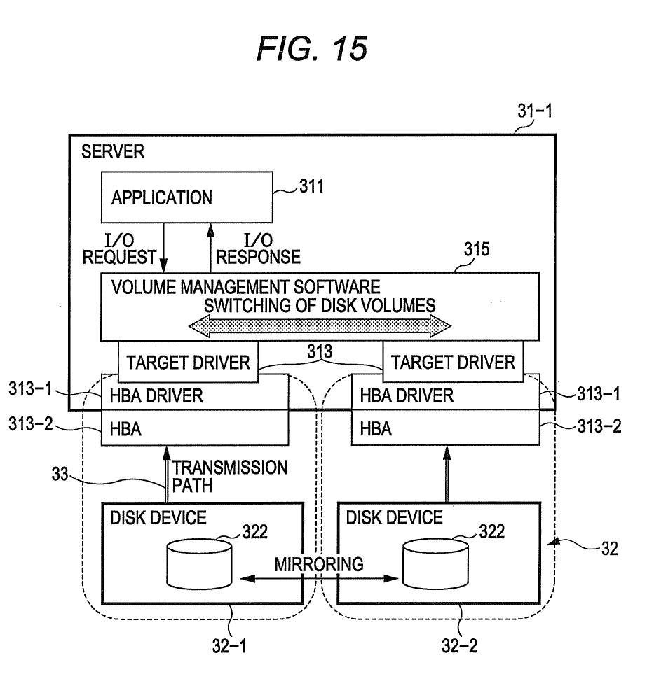

FIG. 15 is a diagram for explaining communication control between a server and a disk array in the second embodiment. The same reference numerals as in FIG. 3 denote the same parts in FIG. 15, and the description thereof is omitted. A system depicted in FIG. 15 has volume management software 315. In a layer structure of the software in the server 31, an application 311, volume management software 315, and a target driver 313 are sequentially arranged from an upper layer.

The volume management software 315 performs mirroring control of disk volumes on a plurality of disk devices 32-1 and 32-2 in the disk array 32. When a disk 322 is abnormal, the volume management software 315 switches disks 322 so as to disconnect the abnormal disk 322 from the mirroring structure and perform an input/output operation on a normal disk 322. When the volume management software 315 receives an I/O request from the application 311 on the upper layer, after a timer which measures an elapsed time of an I/O is started, an I/O issue request is issued to the target driver 313. Thereafter, the volume management software 315 monitors a response from the target driver 313 to the issued I/O issue request. When an I/O response does not occur within the timeout time of the volume management software 315, the volume management software 315 disconnects the disk 322 on which timeout occurs to prevent the disk 322 from being used. Alternatively, when an I/O response does not occur within the timeout time of the volume management software 315, the volume management software 315 records a change in configuration in a database that manages the configuration of the disk devices 322 to switch the disks 322 (i.e., disk volumes).

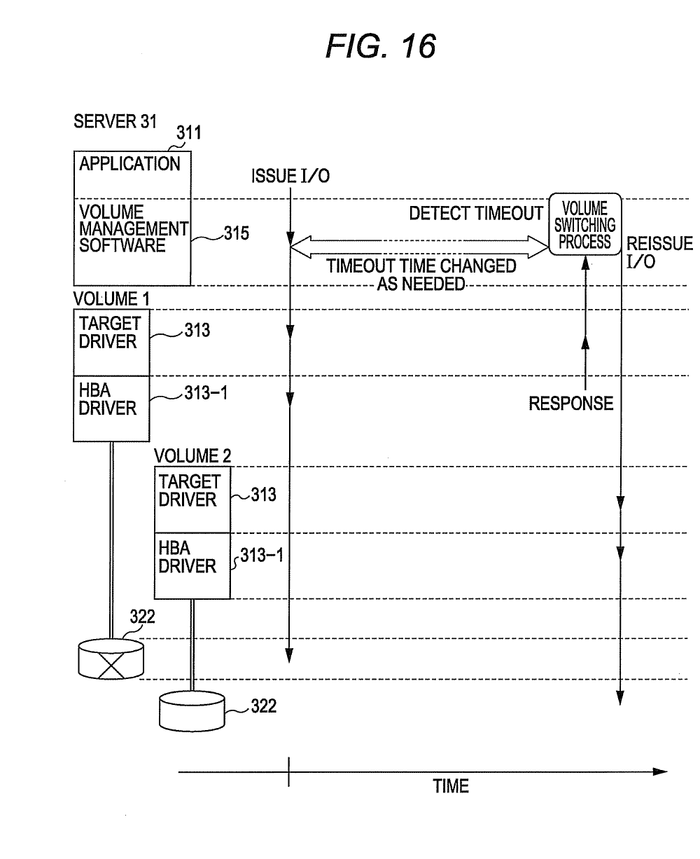

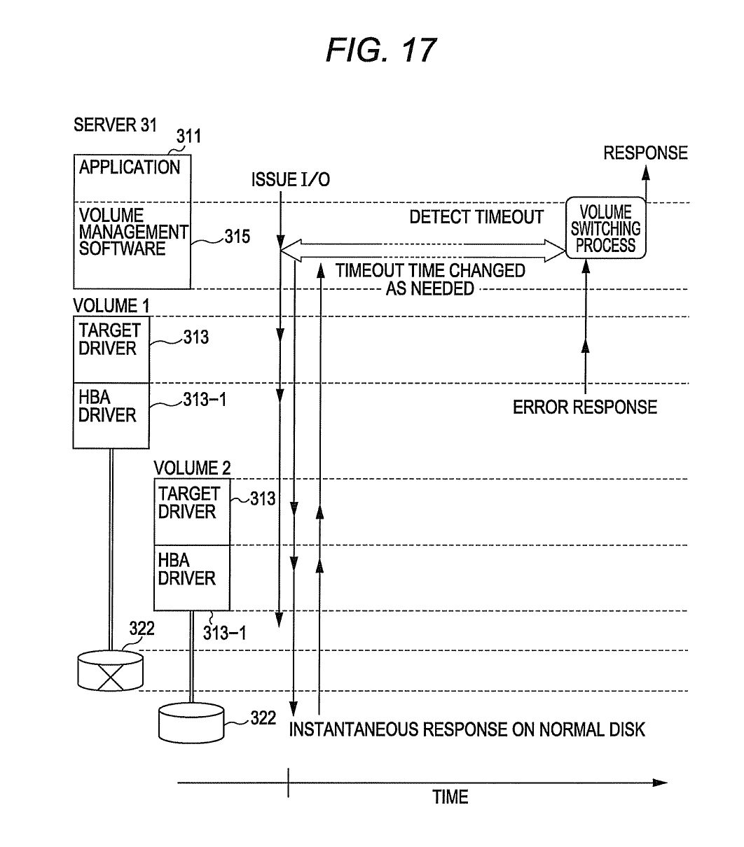

I/O process logics of the volume management software 315 in a read state and a write state are different from each other as depicted in FIGS. 16 and 17. FIG. 16 is a diagram for explaining an operation timing in a read state of the system depicted in FIG. 15, and FIG. 17 is a diagram for explaining an operation timing in a write state of the system depicted in FIG. 15. In FIGS. 16 and 17, errors occurring on the disks 322 are indicated by marks X.

When the volume management software 315 receives an I/O request from the application 311 on a layer higher than that of the volume management software 315 in the layer structure of the software in the server 31, a timeout time (i.e., an I/O response monitoring time) of the target device is elongated as needed. The volume management software 315, the timeout time of which is elongated, issues an I/O issue request to any one of the target drivers 313 on a lower layer after starting an internal timer that measures a time elapsed from the issue of the I/O request. Thereafter, the volume management software 315 monitors an I/O response from the target driver 313 to which an I/O issue request is issued. When an I/O response does not occur within the timeout time by using the elapsed time measured by the internal timer, the volume management software 315 performs a timeout process. In the timeout process, it is determined that an error occurs on the disk 322 of the volume 1 in which timeout occurs, the disk 322 of the volume 1 in which the timeout occurs is disconnected to be prevented from being used, the disk 322 is switched to a disk 322 of another volume 2, and an I/O issue request is reissued to the target driver 313. In this manner, in a connection between the server 31 and the disk array 32, the disks 322 are mirrored by using the volume management software 315. Even though an error occurs on one of the disks 322, the disk volumes are switched to make it possible to continue the mirroring structure.

When the disk array 32 normally operates, the timeout time is elongated such that timeout does not occur even in an overload state. For this reason, the disk 322 is not disconnected.

The volume management software 315 has an I/O management function, a disk volume management function, an I/O monitoring timer function, and a disk array management function. The I/O management function accepts an I/O request from the application 311 on an upper layer and manages an I/O issue request issued to the target driver 313. The I/O management function sets a timeout time in acceptance of an I/O request and monitors an I/O response.

The disk volume is constituted by one of a plurality of disk devices 32-1 and 32-2 in the disk array 32 or a plurality of disk devices 322, and is a unit managed as one region when viewed from an operating system (OS) (not depicted) in the server 31. The disk volume management function manages a mirroring configuration of the disk volume. Actually, the disk volume management function switches instance names of the target drivers 313 to thereby switch disk volumes to be accessed. The disk volume management function manages an issue status of an I/O request to the disk volume. More specifically, the disk volume management function calculates the number of issued I/O issue requests of each disk volume, an average response time, and the like. Furthermore, the disk volume management function manages error statuses of the I/O devices constituting the disk volume. When an error occurs within a predetermined period of time, an error flag is set.

The I/O monitoring timer function periodically starts the I/O monitoring timer (for example, every second), subtracts “1” from an I/O monitoring timer value of a buf structure of all I/O requests that are being issued. The I/O monitoring timer function determines timeout when the I/O monitoring timer value is “0”, and notifies the I/O management function that the I/O monitoring timer value is “0”.

The disk array monitoring timer function periodically (for example, every second) starts the disk array monitoring timer, issues a request sense to an LU of the disk array 32, and checks whether hardware error (failure) information (Sense) is present.

The I/O management function of the volume management software 315 determines whether an I/O monitoring timer value can be elongated by a timeout time setting process a-2, by a process of determining whether the same elongation as that of the I/O management function of the I/O multipath control software 312 in the first embodiment is needed and a process of predicting an I/O response time.

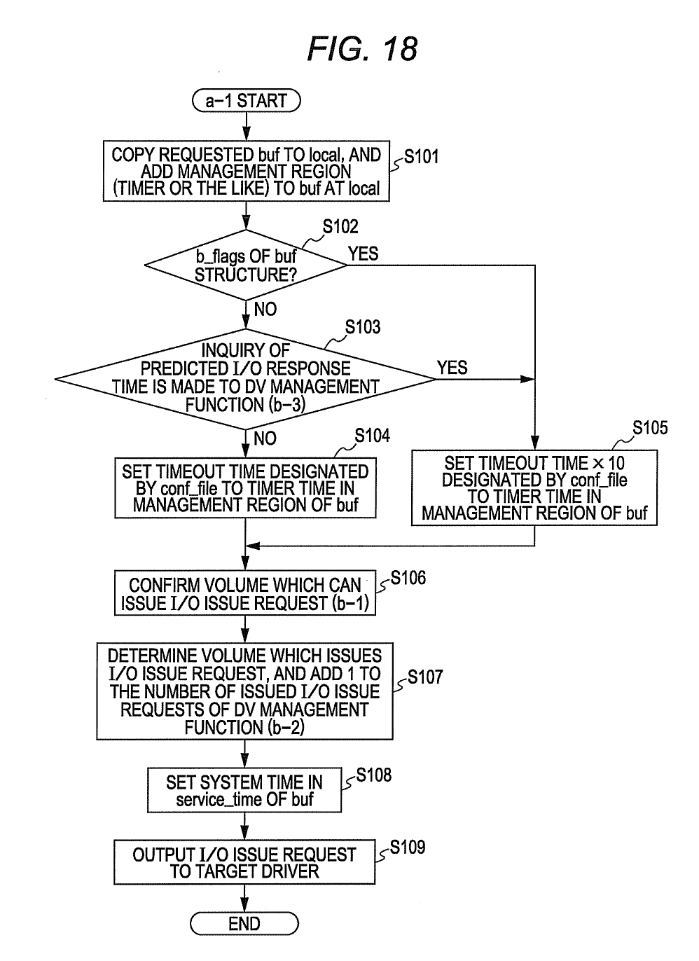

FIG. 18 is a flow chart for explaining an I/O management function of the volume management software 315, and depicts an I/O request accepting process a-1. Steps S101 to S109 depicted in FIG. 18 are basically the same as steps S1 to S9 depicted in FIG. 7, and only different steps S103, S106 and S107 will be described.

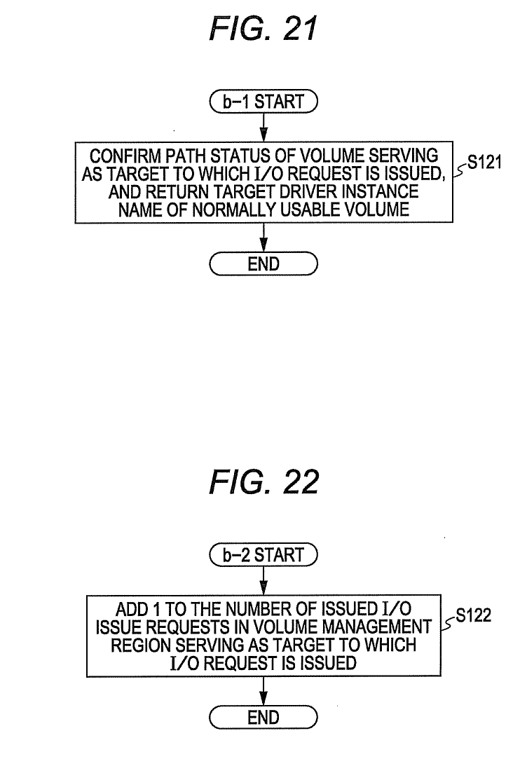

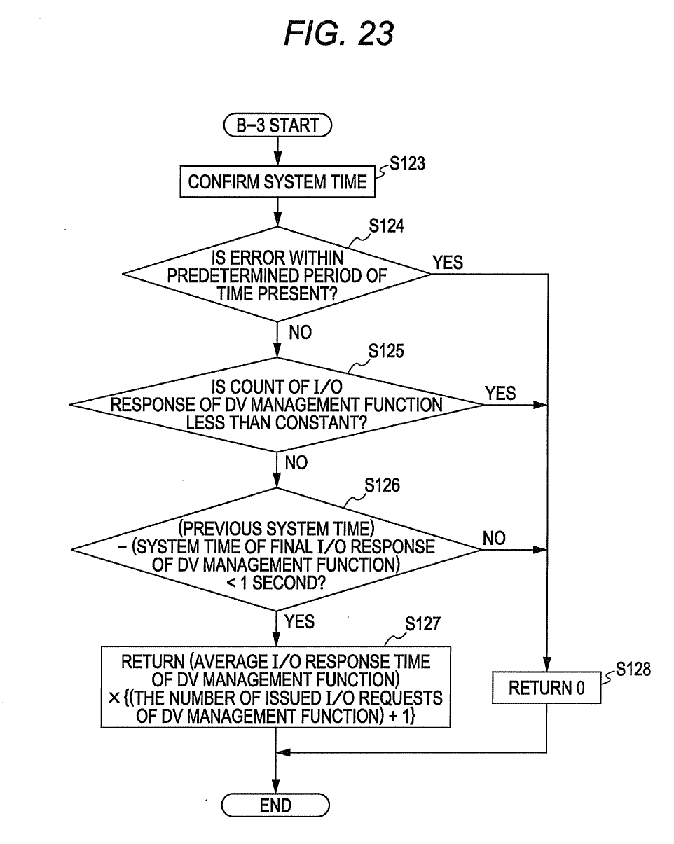

In FIG. 18, in step S103, the disk volume management function is inquired about a prediction response time to an I/O request (I/O response time returning process b-3 described later with reference to FIG. 23), and it is determined whether the prediction response time is a designated timeout time or more. When it is determined that the prediction response time is the designated timeout time or more, the process shifts to step S106. In step S106, a disk volume that can issue an I/O issue request to the disk volume management function is confirmed (path status returning process b-1 described later with reference to FIG. 21). In step S107, the disk volume management function is designated to add “1” to the number of issued I/O issue requests (number-of-issue adding process b-2 described later with reference to FIG. 22).

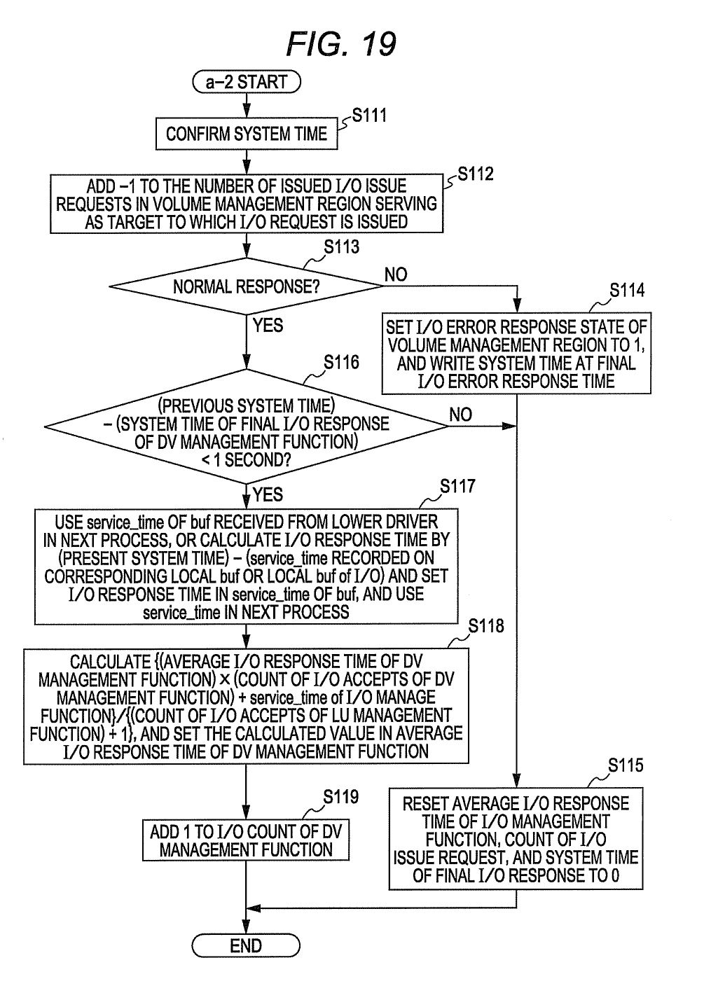

FIG. 19 is a flow chart for explaining an I/O management function of the volume management software 315, and depicts a timeout time setting process a-2. Steps S111 to S119 depicted in FIG. 19 are basically the same as steps S11 to S19 depicted in FIG. 8. Only different steps S112, S114, S116, S118, and S119 will be described here.

In FIG. 19, in step S112, “1” is subtracted from the number of issued I/O issue requests in a disk volume management region of a target device serving as an object to which an I/O request is issued. In step S114, the process is executed when it is determined in step S113 that a normal response does not occur, an I/O error response state in the disk volume management region is set to “1”, and system time is written as final I/O error response time. In step S116, it is determined whether a time obtained by subtracting the system time of the final I/O response managed by the disk volume management function from previous system time is less than 1 second or whether system time of the final I/O response managed by the disk volume management function is “0”. When No is determined in step S116, the process shifts to step S115. When Yes is determined in step S116, the process shifts to step S117. In step S117, a service_time of a buf received from the target driver 313 is prepared to be used in the next process, or an I/O response time obtained by subtracting the service_time put in the local of the target device from present system time is put in the service_time of the buf structure and prepared to be used in the next process. In step S118, {(average I/O response time of disk volume management function)×(count of accepted I/Os of disk volume management function)+(service_time of I/O management function)}/{(count of accepted I/Os of disk volume management function)+1} is calculated to put the calculation value in an average I/O response time of the disk volume management function. In step S119, “1” is added to the count of accepted I/Os of the disk volume management function to end the process.

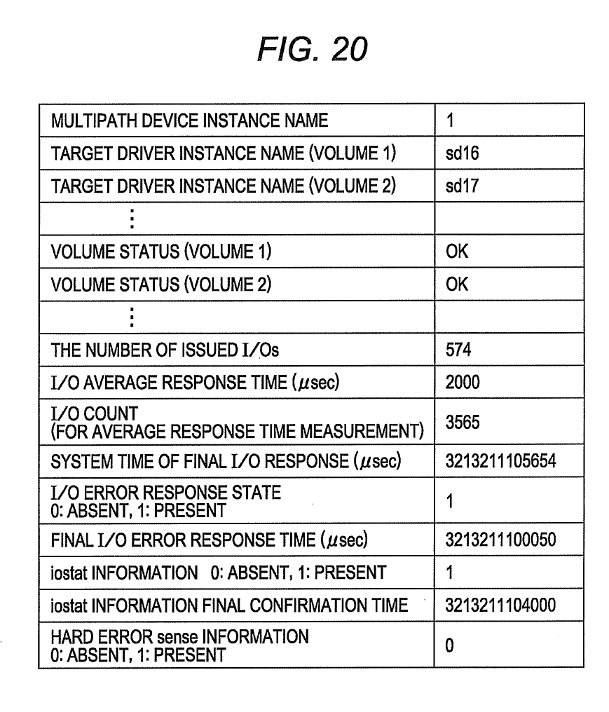

The disk volume management function manages management information depicted in FIG. 20 in units of disk volumes. FIG. 20 is a diagram depicting an example of management information managed by the disk volume management function. As depicted in FIG. 20, the management function includes a multipath device instance name, a target driver instance name (volume 1), a target driver instance name (volume 2), . . . , a target driver instance name (volume N), a volume status (volume 1), . . . , a volume status (volume 2), . . . , a volume status (volume N), the number of issued I/O requests, an average I/O response time, the number of accepted I/Os for measuring the average I/O response time, system time of final I/O response, an I/O error response state, final I/O error response time, iostat information, iostat information final confirmation time, and hardware error sense information.

FIG. 21 is a flow chart for explaining a disk volume management function of the volume management software 315, and depicts a path status returning process b-1. Step S121 depicted in FIG. 10 is basically the same as step S21 depicted in FIG. 8.

In FIG. 21, when an inquiry is made in step S106 depicted in FIG. 18, in step S121, a path status of a disk volume serving as an object to which an I/O request is issued is confirmed, a target driver instance name of a disk volume which can be normally used is returned to end the process.

FIG. 22 is a flow chart for explaining a disk volume management function of the volume management software 315, and depicts an number-of-issue adding process B-2. Step S122 depicted in FIG. 22 is basically the same as step S22 depicted in FIG. 11.

In FIG. 22, when a designation is made in step S107 depicted in FIG. 18, in step S122, “1” is added to the number of issued I/O issue requests in a management region of a disk volume serving as an object to which an I/O response is issued to end the process.

FIG. 23 is a flow chart for explaining the disk volume management function of the volume management software 315, and depicts an I/O response time returning process b-3. Steps S123 to S128 depicted in FIG. 23 are the same as steps S23 to S28 depicted in FIG. 12.

In FIG. 23, when an inquiry about a prediction response time is made in step S103 depicted in FIG. 18, in step S123, system time is confirmed. In step S124, it is determined, based on statistic information, whether an error occurring within a predetermined period of time is present. In step S124, for example, in an I/O error response state, when iostat information has an error, and when information within a predetermined period of time is present, it is determined that an error is present. When hardware error sense information is present, it is determined that an error is present. When a determination result in step S124 is NO, in step S125, it is determined whether a count of I/O responses of the disk volume management function is less than, for example, max_throttle×4(255×4). When a determination result in step S125 is NO, in step S126, it is determined whether a time obtained by subtracting system time of a final I/O response managed by the disk volume management function from previous system time is less than 1 second. When a determination result in step S126 is YES, in step S127, (average I/O response time)×{(the number of issued I/O requests)+1} managed by the disk volume management function is returned to the I/O management function to end the process. On the other hand, when the determination result in step S124 or S125 is YES, or when the determination result in step S126 is NO, in step S128, “0” is returned to the I/O management function to end the process.

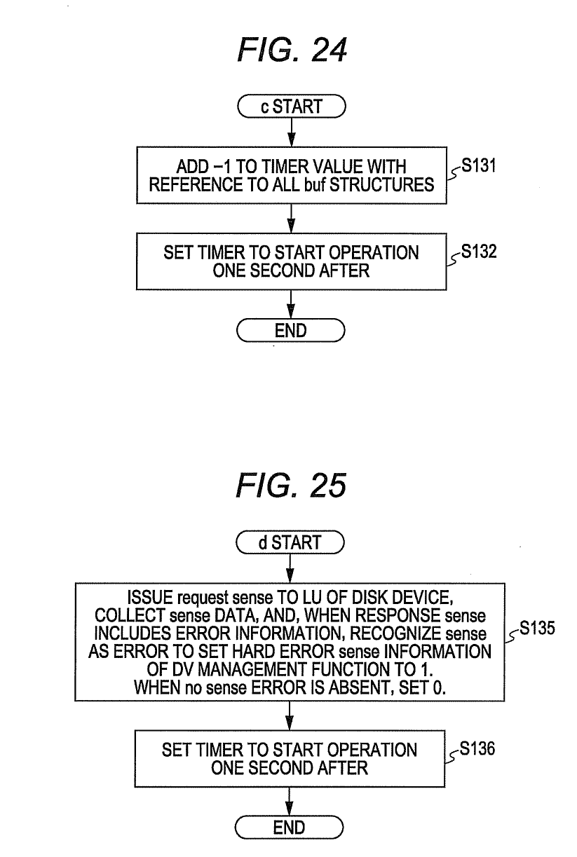

FIG. 24 is a flow chart for explaining an I/O monitoring timer function of the volume management software 315. Steps S131 and S132 depicted in FIG. 24 are basically the same as steps S31 and S32 depicted in FIG. 13.

In FIG. 24, when the I/O monitoring timer function is started, in step S131, “1” is subtracted from an I/O monitoring timer value with reference to all buf structures. In step S132, a self-timer is set such that the I/O monitoring timer function is started, for example, 1 second after to end the process.

FIG. 25 is a flow chart for explaining a disk array monitoring timer function of the volume management software 315. Steps S135 and S136 depicted in FIG. 25 are basically the same as steps S35 and S36 depicted in FIG. 14.

In FIG. 25, when the disk array monitoring timer function is started, in step S135, a request sense is issued to each LU of the disk array 32 to collect sense information. In step S135, the sense information to the request sense has error information, hardware error sense information of the LU management function is set to “1” as an error. When a hardware error is not present, (no sense) “0” is set. In step S136, the self-timer is set such that the disk array monitoring timer function is started, for example, 1 second after to end the process.

According to the embodiment, a timeout time of each I/O device is elongated as needed to make it possible to prevent an overload state of the I/O device from being erroneously detected as occurrence of an error. Furthermore, when the timeout time of each I/O device is elongated as needed, a normally operated I/O device can be prevented from being needlessly disconnected, or a path to the normally operated I/O device is prevented from being needlessly switched.

### Third Embodiment

An input/output control method, an information processing apparatus, and a computer-readable recording medium according to a third embodiment will be described below. In this embodiment, the case in which the present invention is applied to I/O multipath control software and volume management software will be described.

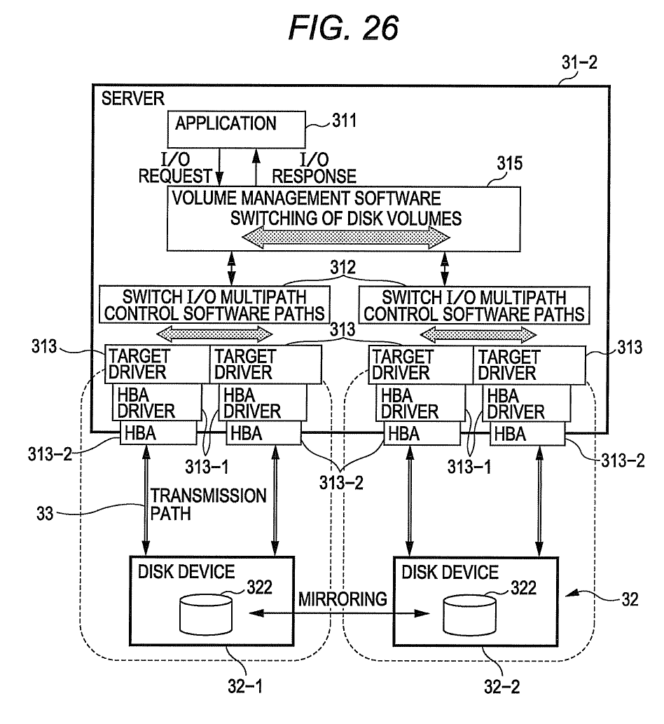

FIG. 26 is a diagram for explaining communication control between a server and a disk array in the third embodiment. The same reference numerals as in FIGS. 3 and 15 denote the same parts in FIG. 26, and the description thereof is omitted. A system depicted in FIG. 26 has I/O multipath control software 312 and volume management software 315. In a layer structure of the software in the server 31, an application 311, volume management software 315, I/O multipath control software 312, and a target driver 313 are sequentially arranged from an upper layer. In this case, two target drivers 313-1 on a main path side are made redundant, and two target drivers 313-1 on a redundant channel side are also made redundant. Two pairs of HBA drivers and HBA adapters on the main path side are made redundant, and two pairs of HBA drivers and HBA adapters on the redundant channel side are made redundant. Furthermore, a disk device 322 on the main path side and the disk device 322 on the redundant channel side are made redundant.

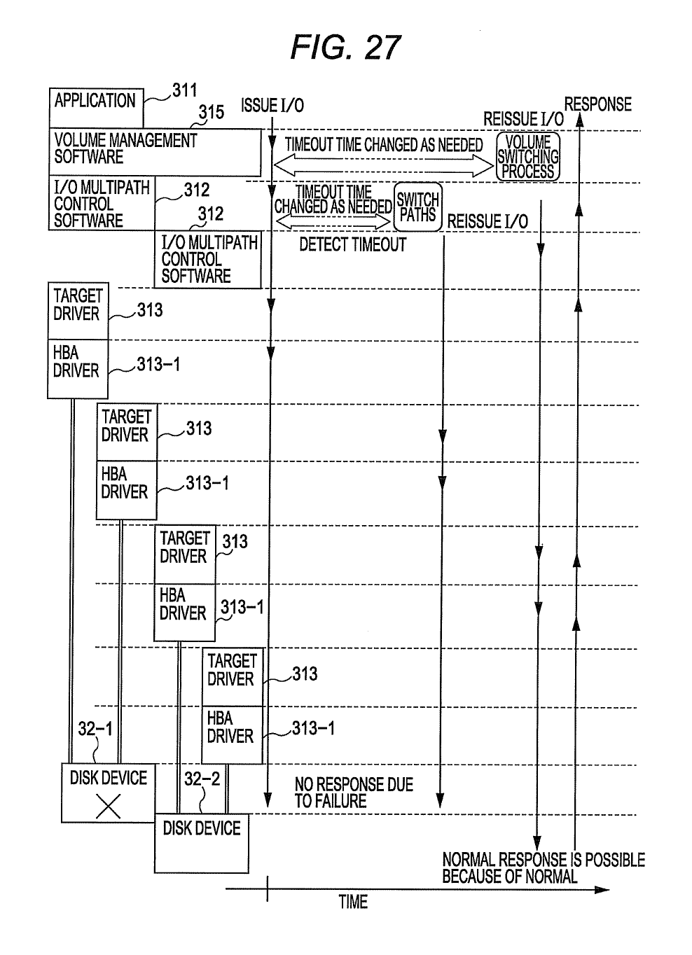

FIG. 27 is a diagram for explaining an operation timing of a system depicted in FIG. 26. Requirements of the functions of the target driver 313, the HBA driver 313-1, and the I/O multipath control software 312 when an I/O response time is predicted from statistic information related to the I/O response time are as follows. As the requirements of the target driver 313 and the HBA driver 313-1 on a lower layer of the I/O multipath control software 312, a function that notifies the I/O multipath control software 312 of the I/O response time is needed. The I/O multipath control software 312 needs a function that notifies the volume management software 315 on the upper layer of the I/O response time received from the target driver 313 or the HBA driver 313-1 on the lower layer through a buf structure. The volume management software 315 calculates an average I/O response time on the basis of the I/O response time received from the I/O multipath control software 312 through the buf structure.

According to the embodiment, when a timeout time of each of the I/O devices is elongated as needed, an overload state of the I/O device is prevented from being erroneously detected as occurrence of an error, a normally operated I/O device can be prevented from being needlessly disconnected, or a path to the normally operated I/O device can be prevented from being needlessly switched.

In each of the embodiments, the case in which the I/O device and the target device are disk devices has been described. However, the I/O device and the target device are not limited to the disk devices, and a magnetic tape device or various storage devices may be used as the I/O device and the target device, as a matter of course.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

The disclosed input/output control method, information processing apparatus, and computer-readable recording medium have been described above with reference to the embodiments. However, the disclosed input/output control method, information processing apparatus, and computer-readable recording medium are not limited to the embodiments. Various changes and modifications of the invention can be made without departing from the spirit and scope of the invention, as a matter of course.

What is claimed is:

1. An input/output control method for an information processing apparatus that is connected to an input/output device through first and second paths, monitors an input/output response to an input/output request issued to the input/output device through the first path, and performs a timeout process when the input/output response is not present within a timeout time, the method comprising:
predicting a timeout time to the input/output request based on statistic information that the information processing apparatus obtains by monitoring the input/output response;
detecting an error on the first path when an input/output response to the input/output request is not present within the predicted timeout time; and
disconnecting the first path when the error on the first path is detected.

2. The input/output control method for an information processing apparatus according to claim 1, further comprising:
issuing the input/output request via the second path after the first path is disconnected.

3. The input/output control method according to claim 1, wherein
an average response time until a response is returned from the input/output device after the input/output request is issued to the input/output device is used as the statistic information when predicting the timeout time.

4. The input/output control method according to claim 1, wherein
a product of the number of input/output requests that are being processed in the information processing apparatus and an average response time until a response is returned from the input/output device after the input/output request is issued to the input/output device is used as the statistic information when predicting the timeout time.

5. The input/output control method according to claim 1, wherein
the input/output device has a first input/output device connected to the first path and a second input/output device connected to the second path, and
the first input/output device and the second input/output device are made redundant.

6. An information processing apparatus that is connected to an input/output device through a first path and a second path, monitors an input/output response to an input/output request issued to the input/output device through the first path, and performs a timeout process when the input/output response is not present within a timeout time, the information processing apparatus comprising:
a prediction unit that predicts a timeout time to the input/output request based on statistic information that the information processing apparatus obtains by monitoring the input/output response;
a detection unit that detects an error on the first path when an input/output response to the input/output request is not present within the predicted timeout time; and
a disconnection unit that disconnects the first path when the error on the first path is detected.

7. The information processing apparatus according to claim 6, further comprising:
an issuing unit that issues the input/output request via the second path after the first path is disconnected.

8. The information processing apparatus according to claim 6, wherein the prediction unit uses an average response time until a response is returned from the input/output device after the input/output request is issued to the input/output device as the statistic information.

9. The information processing apparatus according to claim 6, wherein
the prediction unit uses a product of the number of input/output requests of input/output requests to be issued to the input/output device that are being processed in the information processing apparatus and an average response time until a response is returned from the input/output device after the input/output request is issued to the input/output device as the statistic information.

10. The information processing apparatus according to claim 6, wherein
the input/output device has a first input/output device connected to the first path and a second input/output device connected to the second path, and the first input/output device and the second input/output device are made redundant.

11. A computer-readable recording medium storing an input/output control program for an information processing apparatus that is connected to an input/output device through first and second paths, monitors an input/output response to an input/output request issued to the input/output device through the first path, and performs a timeout process when the input/output response is not present within a timeout time, the program when executed by a computer causes the computer to perform a method comprising:
predicting a timeout time to the input/output request based on the basis of statistic information that the information processing apparatus obtains by monitoring the input/output response;
detecting an error on the first path when an input/output response to the input/output request is not present within the predicted timeout time; and
disconnecting the first path when the error on the first path is detected.

12. The computer-readable recording medium according to claim 11, wherein the input/output program further causes the computer to perform:
issuing the input/output request via the second path after the first path is disconnected.

13. The computer-readable recording medium according to claim 11, wherein
the predicting uses an average response time until a response is returned from the input/output device after the input/output request is issued to the input/output device as the statistic information.

14. The computer-readable recording medium according to claim 11, wherein
the predicting uses a product of the number of input/output requests, of input/output requests to be issued to the input/output device that are being processed in the information processing apparatus, and an average response time until a response is returned from the input/output device after the input/output request is issued to the input/output device as the statistic information.

15. The computer-readable recording medium according to claim 11, wherein
the input/output device has a first input/output device connected to the first path and a second input/output device connected to the second path, and
the first input/output device and the second input/output device are made redundant.
